(19) United States
(12) Patent Application Publication
(10) Pub. No.: US 2013/0058836 A1
(43) Pub. Date: Mar. 7, 2013

(54) CATALYST FILTER

(71) Applicant: Evgeniy Petrovich Osinenko, Tomsk (RU)

(72) Inventor: Evgeniy Petrovich Osinenko, Tomsk (RU)

(21) Appl. No.: 13/580,256

(22) PCT Filed: Mar. 3, 2011
(86) PCT No.: PCT/RU11/00133

§ 371 Date: Aug. 21, 2012

(30) Foreign Application Priority Data
Mar. 23, 2010 (RU) 2010110719

(51) Int. Cl. B01J 19/00

(52) U.S. Cl. 422/129

(57) ABSTRACT

Catalyst filter wherein a nonwoven material with a density of no more than 50 kg/m³, or within 50-1500 kg/m³ range, selected from the group comprising silica fiber, carbon fiber, basalt fiber, synthetic fiber and nonwoven fabric fiber with melting temperature not less than 100° C., is impregnated with: (a) powder of catalyst, selected from the group, comprising Pt, Rh, Pd, Ag, Au, Re and/or alloys and/or salts of the said metals in any combination, with the catalyst powder particles size of 0,01-3000 μm, or (b) powder of metal, selected from the group comprising Zn, Fe, Al, Ti, Ni, Cu, Co, coated with a layer of catalyst, selected from the group comprising Pt, Rh, Pd, Ag, Au, Re and/or alloys and/or salts of the said metals in any combination, with the catalyst-coated metal powder particles size of 0,01-3000 μm.

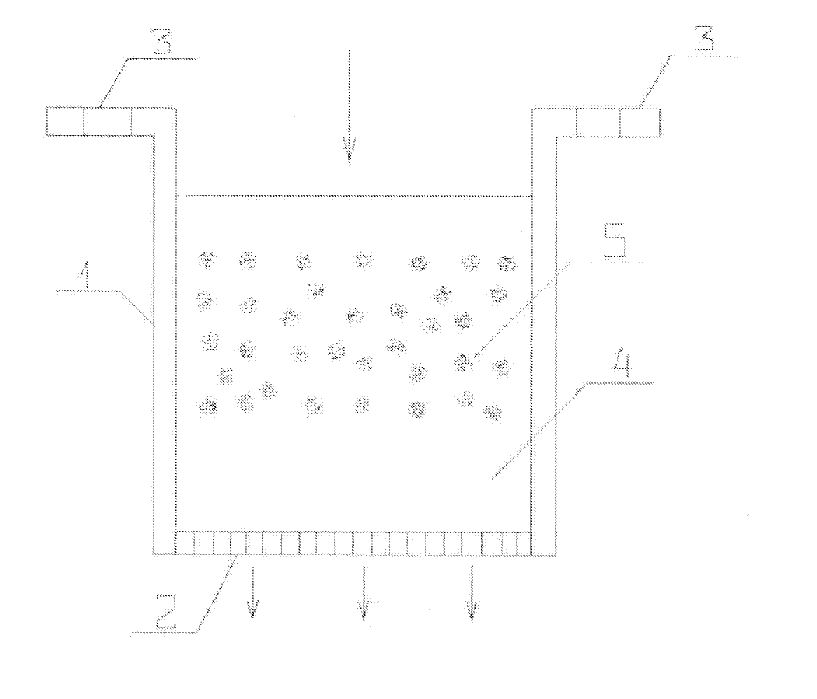

### CROSS-REFERENCE TO RELATED APPLICATIONS

This application is a U.S. national stage application of the PCT application PCT/RU2011/000133 filed on 3 Mar. 2011, whose disclosure is incorporated herein in its entirety by reference, which PCT application claims priority of a Russian Federation application RU2010110719 filed on 23 Mar. 2010.

### FIELD OF THE INVENTION

The invention relates to a catalyst filter with high catalytic properties and is intended for use in petrochemical processing and catalytic reduction of substances from gases and solutions.

### BACKGROUND OF THE INVENTION

The most common use of platinum is as a catalyst in chemical reactions, many times as platinum black. It has been employed in this application since the early 19th century, when platinum powder was used to catalyze the ignition of hydrogen. Its most important application is in automobiles as a catalytic converter, which allows the complete combustion of low concentrations of unburned hydrocarbons from the exhaust into carbon dioxide and water vapor. Platinum is also used in the petroleum industry as a catalyst in a number of separate processes, but especially in catalytic reforming of straight run naphthas into higher-octane gasoline which becomes rich in aromatic compounds. PtO₂, also known as Adams' catalyst, is used as a hydrogenation catalyst, specifically for vegetable oils. Platinum metal also strongly catalyzes the decomposition of hydrogen peroxide into water and oxygen gas (source of information: http://en.wikipedia.org/wiki/Platinum).

According to http://en.wikipedia.org/wiki/Platinum one of the most important application of platinum is in automobiles as a catalytic converter, which allows the complete combustion of low concentrations of unburned hydrocarbons from the exhaust into carbon dioxide and water vapor.

The closest to the technical essence of the given invention, e.g. a prototype of the invention, is the catalytic converter which consists of several components: the catalyst core, which is usually a ceramic monolith with a honeycomb structure, a washcoat, which is a carrier for the catalytic materials and is used to disperse the materials over a high surface area, and the catalyst itself, which is most often a precious metal (source of information: http://en.wikipedia.org/wiki/Catalytic_converter).

Among disadvantages of the prototype is the large amount of catalyst needed for catalytic converter.

### OBJECTIVES AND DESCRIPTION OF THE INVENTION

The given invention is aimed at increasing the efficiency of a catalyst filter at a lower consumption of metal-catalysts. For proper understanding the notions described herein the following terms are used:

Catalyst—the substances, changing the rate of chemical reactions through a multiple intermediate interaction with the reagents and not contained in the resulting products.

Metal catalyst—a powder of a catalyst, selected from the group comprising Pt, Rh, Pd, Ag, Au, Re, and/or alloys and/or salts of these metals in any combination.

Nonwoven materials—materials, fabrics and items made of fiber, filaments and/or other types of natural and/or synthetic materials without spinning and weaving. Nonwoven materials are fiberglass, silica fiber, carbon fiber, basalt fiber and other known nonwoven materials.

Aqua regia—a mixture of concentrated acids—hydrochloric acid (HCl) and nitric acid (HNO₃) in ratio 3:1 by volume. The above mentioned technical result according to the invention is achieved as follows:

A nonwoven material with a density of no more than 50 kg/m³, or 50-100 kg/m³, or 100-200 kg/m³, or within 200-500 kg/m³, or within 500-1000 kg/m³, or within 500-1500 kg/m³, or within 1000-1500 kg/m³, or within 50-1500 kg/m³ range, selected from the group comprising silica fiber, carbon fiber, basalt fiber, synthetic fiber and nonwoven fabric fiber with melting temperature not less than 100° C., is impregnated with: (a) powder of catalyst, selected from the group, comprising Pt, Rh, Pd, Ag, Au, Re and/or alloys and/or salts of the said metals in any combination, with the catalyst powder particles size of 0,01-10 μm, or 0,01-40 μm, or 0,01-100 μm, or 40-100 μm, or 40-500 μm, or 40-1000 μm, or 100-500 μm, or 100-1000 μm, or 100-2000 μm, or 1000-2000 μm, or 1000-3000 μm, or 2000-3000 μm, or (b) powder of metal, selected from the group comprising Zn, Fe, Al, Ti, Ni, Cu, Co, coated with a layer of catalyst, selected from the group comprising Pt, Rh, Pd, Ag, Au, Re and/or alloys and/or salts of the said metals in any combination, with the catalyst-coated metal powder particles size of 0,01-10 μm, or 0,01-40 μm, or 0,01-100 μm, or 40-100 μm, or 40-500 μm, or 400-1000 μm, or 100-500 μm, or 100-1000 μm, or 100-2000 μm, or 1000-2000 μm, or 1000-3000 μm, or 2000-3000 μm, herewith:

catalyst powder as per (a) or catalyst-coated metal powder as per (b), is placed into the said nonwoven material via soaking the said nonwoven material in an aqueous suspension of the catalyst or the catalyst-coated metal, prepared in the ratio of one part of water and one part of the catalyst or catalyst-coated metal, or in such a ratio, that will allow the catalyst or catalyst-coated metal to penetrate into the said nonwoven material;

the body of the catalyst filter incorporates at least one filtering cartridge with the said nonwoven material, which is impregnated with the said catalyst powder or catalyst-coated metal powder;

the catalyst filter is connected with a pipe that feeds gas and/or solution, which undergo catalytic transformation when passing through the filtering cartridge, and go out through the bottom of the filter body.

Coating of the powder metal, selected from the group comprising Zn, Fe, Al, Ti, Ni, Cu, Co, with a catalyst, selected from the group comprising Pt, Rh, Pd, Ag, Au, Re and/or salts of these elements in any combination, can be carried out via mixing the water suspension (one part of the said metal and one part of water) with a catalyst, dissolved in aqua regia, herewith obtained solution with precipitated catalyst-coated particles of the said metal is being jetted by a pump onto the metal wall, resulting into destruction of coalesced particles of the catalyst-coated metal to approximately initial size of particles of the said powder metal.

Nonwoven fiber may be impregnated with an aqueous suspension of a powder catalyst or a catalyst-coated powder metal in the ratio of 1 part of the catalyst powder or catalyst-coated powder metal and 1-10 parts of water; the nonwoven fiber impregnated with this slurry may be rolled and inserted into the catalyst filter body.

Powder catalyst or catalyst-coated powder metal may be placed in the said nonwoven material evenly.

Catalyst filter may be connected via a flange to a pipe that feeds gas and/or solution, which undergoes catalytic transformation when passing through the filtering cartridge.

The catalyst filter bottom may have holes 0.1-5 mm in diameter.

The catalyst filter may have cylindrical body.

### EMBODIMENT OF THE INVENTION

The given invention is considered implementable due to the technical solutions applications, which are known from the background art.

The embodiment of the catalyst filter of the given invention is shown in the drawing figure attached hereto and consists of the following: a filtering cartridge 4 made of a nonwoven material with an evenly placed powder catalyst 5 is inserted into cylindrical body 1 on the side of a flange 3. Catalyst filter is connected via the flange 3 to a pipe that feeds gas/solution, which undergoes catalytic transformation. The said gas or solution passes through the filtering cartridge 4 and after catalytic transformation goes out of the bottom 2 of the cylindrical body through 0.1-5 mm holes.

### APPLICATIONS OF THE INVENTION

The given invention may be applied in catalyst filters used for petrochemical procession of oil, production of nitric acid and catalytic reduction of substances from gases and solutions.

The given invention allows increasing the catalyst surface area several times at the same level of consumption of metal-catalysts compared to techniques and equipment known in the background art.

1. Catalyst filter wherein a nonwoven material with a density of no more than 50 kg/m³, or 50-100 kg/m³, or 100-200 kg/m³, or within 200-500 kg/m³, or within 500-1000 kg/m³, or within 500-1500 kg/m³, or within 1000-1500 kg/m³, or within 50-1500 kg/m³ range, selected from the group comprising silica fiber, carbon fiber, basalt fiber, synthetic fiber and nonwoven fabric fiber with melting temperature not less than 100° C., is impregnated with powder of catalyst, selected from the group, comprising Pt, Rh, Pd, Ag, Au, Re and/or alloys and/or salts of the said metals in any combination, with the catalyst powder particles size of 0,01-10 μm, or 0,01-40 μm, or 0,01-100 μm, or 40-100 μm, or 40-500 μm, or 40-1000 μm, or 100-500 μm, or 100-1000 μm, or 100-2000 μm, or 1000-2000 μm, or 1000-3000 μm, or 2000-3000 μm, herewith catalyst powder is placed into the said nonwoven material via soaking the said nonwoven material in a aqueous suspension of the catalyst, prepared in the ratio of one part of water and one part of the catalyst or in such a ratio that allows the catalyst to penetrate into the said nonwoven material.

2. Catalyst filter wherein a nonwoven material with a density of no more than 50 kg/m³, or 50-100 kg/m³, or 100-200 kg/m³, or within 200-500 kg/m³, or within 500-1000 kg/m³, or within 500-1500 kg/m³, or within 1000-1500 kg/m³, or within 50-1500 kg/m³ range, selected from the group comprising silica fiber, carbon fiber, basalt fiber, synthetic fiber and nonwoven fabric fiber with melting temperature not less than 100° C., is impregnated with powder of catalyst, selected from the group, comprising Pt, Rh, Pd, Ag, Au, Re and/or alloys and/or salts of the said metals in any combination, with the catalyst powder particles size of 0,01-10 μm, or 0,01-40 μm, or 0,01-100 μm, or 40-100 μm, or 40-500 μm, or 40-1000 μm, or 100-500 μm, or 100-1000 μm, or 100-2000 μm, or 1000-2000 μm, or 1000-3000 μm, or 2000-3000 μm, herewith catalyst powder is placed into the said nonwoven material via soaking the said nonwoven material in a aqueous suspension of the catalyst, prepared in the ratio of one part of water and one part of the catalyst or in such a ratio that allows the catalyst to penetrate into the said nonwoven material.

3-7. (canceled)
